(19) United States
(12) Patent Application Publication
(10) Pub. No.: US 2026/0177964 A1
(43) Pub. Date: Jun. 25, 2026

(54) IMAGE FORMING APPARATUS AND METHOD FOR FORMING TONER PATTERN

(71) Applicants: Kazuhiko WATANABE, Tokyo (JP); Takaaki TAWADA, Kanagawa (JP); Hirofumi FUJII, Kanagawa (JP)

(72) Inventors: Kazuhiko WATANABE, Tokyo (JP); Takaaki TAWADA, Kanagawa (JP); Hirofumi FUJII, Kanagawa (JP)

(73) Assignee: ETRIA Co., Ltd., Kanagawa (JP)

(21) Appl. No.: 19/418,057

(22) Filed: Dec. 12, 2025

(30) Foreign Application Priority Data
Dec. 24, 2024 (JP) 2024-227699

(51) Int. Cl. G03G 15/00; G03G 15/01; G03G 15/16

(52) U.S. Cl. CPC G03G 15/5054; G03G 15/0131; G03G 15/161; G03G 2215/1661

(57) ABSTRACT

An image forming apparatus includes intermediate-transferor facing members including an image bearer, an intermediate transferor; a transferor to transfer the toner image from the intermediate transferor, a cleaner to clean a surface of the intermediate transferor, a lubricant supplier to supply a lubricant to one of the intermediate-transferor facing members, and circuitry to form a toner pattern, on the surface of the image bearer, in a portion where the image is not formed, control the transferor to input the toner pattern to a contact portion of the cleaner with the image bearer, determine whether a non-supply portion is present on the intermediate transferor due to a decrease in the lubricant supplied from the lubricant supplier, and increase an amount of toner in the toner pattern input to the contact portion of the cleaner based on a determination result that the non-supply portion is present on the intermediate transferor.

### CROSS-REFERENCE TO RELATED APPLICATIONS

This patent application is based on and claims priority pursuant to 35 U.S.C. § 119(a) to Japanese Patent Application No. 2024-227699, filed on Dec. 24, 2024, in the Japan Patent Office, the entire disclosure of which is hereby incorporated by reference herein.

### BACKGROUND

### Technical Field

The present disclosure relates to an image forming apparatus and a method for forming a toner pattern.

### Related Art

There is an image forming apparatus including: an image bearer on which a toner image of an image to be formed is formed; intermediate transferor to which the toner image of the image bearer is transferred; a transferor that transfers the toner image of the intermediate transferor to a recording medium; a cleaner that cleans a surface of the intermediate transferor after the toner image is transferred to the recording medium; a lubricant supplier that supplies a lubricant to an intermediate-transferor facing member facing the intermediate transferor, including the image bearer; and a toner input controller that forms a toner pattern on a portion of the surface of the image bearer on which the image is not formed, transfers the toner pattern onto the intermediate transferor, and inputs the toner pattern to a contact portion of the cleaner.

For example, there has been proposed an image forming apparatus in which a lubricant is supplied to at least one of the image bearer as the intermediate-transferor facing member and the transferor by the lubricant supplier, and the lubricant supplied to at least one of the image bearer and the transferor is indirectly supplied to the intermediate transferor.

Then, in the image forming apparatus, the toner amount to be input to the contact portion of the cleaner is changed to be larger in an image formation mode in which the lubricant is less likely to be indirectly supplied from one or both of the image bearer and the transferor to the intermediate transferor than in an image formation mode in which the lubricant is more likely to be indirectly supplied.

### SUMMARY

The present disclosure described herein provides an image forming apparatus including multiple intermediate-transferor facing members including an image bearer on which a toner image is formed, an intermediate transferor, disposed facing the multiple intermediate-transferor facing member, to which the toner image is transferred from the image bearer, a transferor to transfer the toner image from the intermediate transferor onto a recording medium, a cleaner to clean a surface of the intermediate transferor after the toner image is transferred onto the recording medium, a lubricant supplier to supply a lubricant to one intermediate-transferor facing member of the multiple intermediate-transferor facing members, and circuitry. The circuitry is to form a toner pattern, on the surface of the image bearer, in a portion where the image is not formed, control the transferor to transfer the toner pattern onto the intermediate transferor and input the toner pattern to a contact portion of the cleaner with the image bearer, determine whether a non-supply portion is present on the intermediate transferor, and increase an amount of toner in the toner pattern input to the contact portion of the cleaner based on a determination result that the non-supply portion is present on the intermediate transferor. The non-supply portion is a portion where the lubricant is not supplied via the one intermediate-transferor facing member due to a decrease in the lubricant supplied from the lubricant supplier.

The present disclosure described herein provides an image forming apparatus including an image bearer; a means for forming a toner pattern, on a surface of an image bearer, in a portion where a toner image to be transferred onto a recording medium is not formed; an intermediate transferor disposed facing the image bearer, to which the toner image is transferred from the image bearer; a means for primarily transferring the toner pattern from the image bearer onto the intermediate transferor; a means for secondarily transferring the toner image from the intermediate transferor onto the recording medium; a means for cleaning a surface of the intermediate transferor after the toner image is transferred onto the recording medium; a means for supplying a lubricant to the intermediate transferor via the image bearer; a means for inputting the toner pattern to a contact portion of the means for cleaning with the image bearer; a means for determining whether a non-supply portion is present on the intermediate transferor, the non-supply portion being a portion where a lubricant is not supplied due to a decrease in the lubricant supplied from the means for supplying; and a means for increasing an amount of toner in the toner pattern input to the contact portion of the cleaner based on a determination result that the non-supply portion is present.

The present disclosure described herein provides a method for forming a toner pattern. The method includes forming a toner pattern, on a surface of an image bearer, in a portion where a toner image to be transferred onto a recording medium is not formed; controlling a transferor to transfer the toner pattern onto an intermediate transferor and input the toner pattern to a contact portion of a cleaner with the image bearer; determining whether a non-supply portion is present on the intermediate transferor, the non-supply portion being a portion where a lubricant is not supplied; and increasing an amount of toner in the toner pattern input to the contact portion of the cleaner based on a determination result that the non-supply portion is present.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a copier;

FIG. 2 is an enlarged diagram illustrating a part of the copier illustrated in FIG. 1;

FIG. 3 is a schematic diagram illustrating a gradation pattern on an intermediate transfer belt of the copier illustrated in FIG. 1;

FIG. 4 is a diagram illustrating a sensor of a gradation pattern of the copier illustrated in FIG. 1;

FIG. 5 is a diagram illustrating an input toner pattern of the copier;

FIG. 6 is a flowchart of formation of the input toner pattern of the copier;

FIGS. 7A and 7B are diagrams illustrating an example of the input toner pattern of the copier;

FIGS. 8A and 8B are diagrams illustrating another example of the input toner pattern of the copier;

FIG. 9 is a flowchart of creation of the input toner pattern of the copier;

FIG. 10 is a diagram illustrating a solid lubricant of the copier;

FIG. 11 is a diagram illustrating depletion of the solid lubricant of the copier;

FIG. 12 is a diagram illustrating an input toner pattern for blade-curling due to lubricant depletion of the copier;

FIG. 13 is a diagram illustrating another input toner pattern of the copier;

FIG. 14 is a block diagram of the copier; and

FIG. 15 is a flowchart of the copier.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A copier 500, which is a tandem color copier, is described below as an example of image forming apparatus.

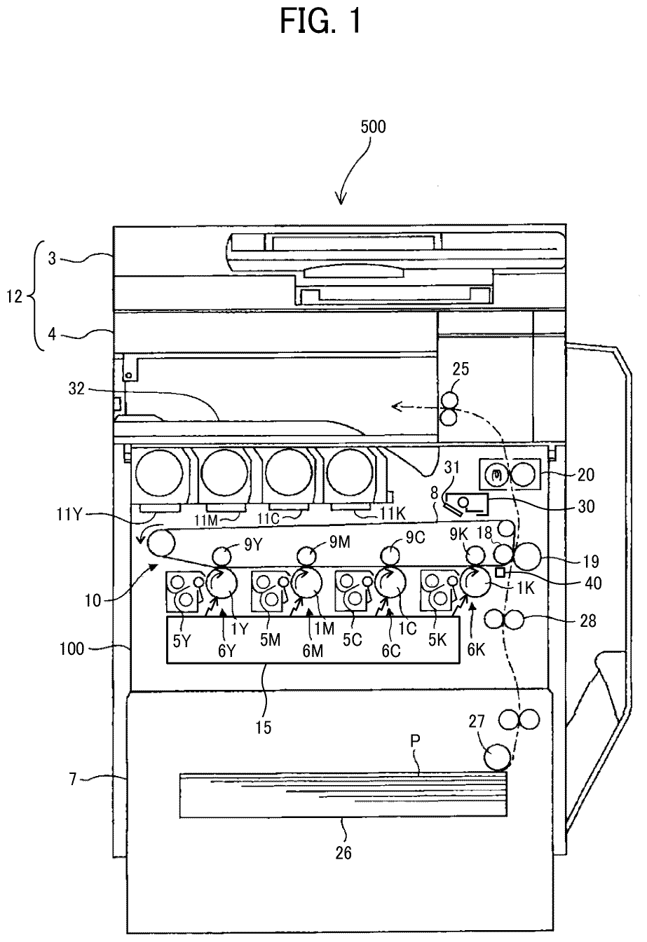

FIG. 1 is a schematic view of the copier 500.

The copier 500 includes an image reader 12 above a printer 100 as a main body of the image forming apparatus, and includes a sheet feeder 7 below the printer 100.

The image reader 12 includes a document reader 4 and a document conveyor 3, the document conveyor 3 conveys a document to the document reader 4, and the document reader 4 reads image information of the conveyed document.

The sheet feeder 7 includes a sheet feeding tray 26 in which a transfer sheet P as a recording medium is accommodated, and a sheet feeding roller 27 that feeds the transfer sheet P in the sheet feeding tray 26 toward the printer 100.

The one-dot chain line in FIG. 1 indicates a conveyance path of the transfer sheet P in the copier 500.

An upper portion of the printer 100 is an output tray 32 on which the transfer sheet P on which an output image is formed is stacked.

The printer 100 includes four image forming units 6(Y, M, C, K) as image formers that form toner images of respective colors (yellow, magenta, cyan, black), and an intermediate transfer unit 10.

The printer 100 includes a writer 15 such as an exposure device that writes an electrostatic latent image on the surface of each drum-shaped photoconductor 1(Y, M, C, K) as an image bearer on which the toner image of each color of each image forming unit 6(Y, M, C, K) is formed.

Each of the image forming units 6(Y, M, C, K) includes a developing device 5(Y, M, C, K) that develops an electrostatic latent image on the surface of each photoconductor 1(Y, M, C, K).

The intermediate transfer unit 10 includes an intermediate transfer belt 8 and primary transfer bias rollers 9(Y, M, C, K).

The intermediate transfer belt 8 is an intermediate transferor on which the toner images of the colors on the surfaces of the respective photoconductors 1(Y, M, C, K) are transferred in an overlapping manner to form a color toner image on the surface.

The primary transfer bias rollers 9(Y, M, C, K) are primary transferers that transfer the toner images on the surfaces of the photoconductors 1(Y, M, C, K) to the intermediate transfer belt 8.

The printer 100 includes a secondary transfer bias roller 19 to transfer the color toner image on the intermediate transfer belt 8 onto the transfer sheet P, and a facing roller 18 facing the secondary transfer bias roller 19 via the intermediate transfer belt 8. The secondary transfer bias roller 19, the facing roller 18, and a bias source to apply a transfer bias (voltage) to the facing roller 18 together serve as a transferor to transfer a toner image from the intermediate transfer belt 8 onto a transfer sheet P.

A registration roller pair 28 is provided that adjusts timing of conveying the transfer sheet P fed by the sheet feeding roller 27 to a secondary transfer nip where the intermediate transfer belt 8 and the secondary transfer bias roller 19 face each other.

The printer 100 includes a fixing device 20 that fixes an unfixed toner image on the transfer sheet P above the secondary transfer nip.

Toner bottles 11(Y, M, C, K) of respective colors are disposed below the output tray 32 in the printer 100 and above the intermediate transfer unit 10.

The toner bottles 11(Y, M, C, K) of the respective colors contain toners of the respective colors (yellow, magenta, cyan, black) to be supplied to the respective developing devices 5(Y, M, C, K).

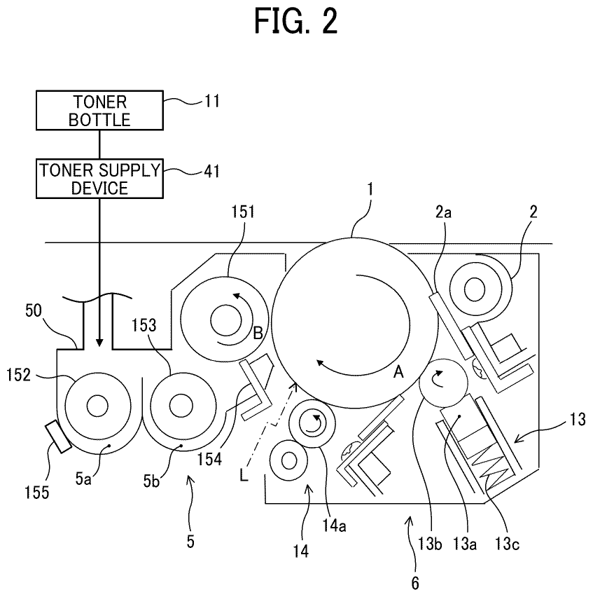

FIG. 2 is an enlarged diagram illustrating one of four image forming units 6(Y, M, C, K).

The configurations and operations of the four image forming units 6(Y, M, C, K) are substantially the same except that the colors of the toners used in the image formation process are different. Therefore, in the following description, reference signs Y, M, C, and K indicating the corresponding colors are appropriately omitted.

As illustrated in FIG. 2, the image forming unit 6 is a process cartridge that integrally supports the photoconductor 1 and the developing device 5, and this process cartridge is attachable to and detachable from the main body of the copier 500.

In addition to the developing device 5, the image forming unit 6 includes a photoconductor cleaning device 2, a lubricant supply device 13, and a charging device 14 around the photoconductor 1.

The lubricant supply device 13 that supplies the lubricant to the photoconductor 1K is a first lubricant supplier, and the lubricant supply device 13 that supplies the lubricant to the photoconductor 1Y, 1M, or 1C is a second lubricant supply device.

In the image forming unit 6, the photoconductor cleaning device 2 cleans the photoconductor 1 with a cleaning blade 2a (cleaner), and the charging device 14 charges the photoconductor 1 using a charging roller 14a.

The developing device 5 includes a first agent storage chamber 5a in which a first conveying screw 152 as a developer conveyor is disposed.

A toner density sensor 155 including a magnetic permeability sensor as a toner density detector, a second conveying screw 153 as a developer conveyor, and a developing roller 151 as a developer carrier are also included.

A second agent storage chamber 5b in which a doctor blade 154 or the like as a developer regulating member is disposed is also included.

The toner density sensor 155 senses the toner density of the developer passing through a predetermined detection portion located downstream in a developer circulating direction of a portion (hereinafter referred to as a “supply position”) facing a toner supply port 5c in the first agent storage chamber 5a.

A developer including a magnetic carrier and a negatively charged toner is stored in the two agent storage chambers forming the circulation path.

The first conveying screw 152 is rotationally driven by a driver to convey the developer in the first agent storage chamber 5a to the front side in the direction orthogonal to the paper surface of FIG. 2.

The developer conveyed to the end of the first agent storage chamber 5a by the first conveying screw 152 enters the second agent storage chamber through a communication port.

The second conveying screw 153 in the second agent storage chamber 5b is rotationally driven by a driver to convey the developer to the back side in the direction orthogonal to the paper surface of FIG. 2.

Above the second conveying screw 153, the developing roller 151 is disposed in a posture parallel to the second conveying screw 153.

The developing roller 151 is configured to include a magnet roller fixedly disposed in a developing sleeve including a nonmagnetic sleeve that is rotationally driven in a counterclockwise direction in FIG. 2 (a direction of an arrow P in the drawing).

A part of the developer conveyed by the second conveying screw 153 is pumped up to the surface of the developing sleeve by the magnetic force generated by the magnet roller.

After the layer thickness is regulated by the doctor blade 154 disposed so as to hold a predetermined gap with respect to the surface of the developing sleeve, the developer is conveyed to a developing region facing the photoconductor 1, and the toner is attached to the electrostatic latent image on the photoconductor 1.

By this attachment, the toner image is formed on the photoconductor 1.

The developer whose toner is consumed by the development is returned to the second conveying screw 153 as the developing sleeve rotates.

The developer conveyed to the end of the second agent storage chamber 5b by the second conveying screw 153 returns into the first agent storage chamber 5a through the communication port provided in a partition wall partitioning the two agent storage chambers.

In this manner, the developer is circularly conveyed in the developing device.

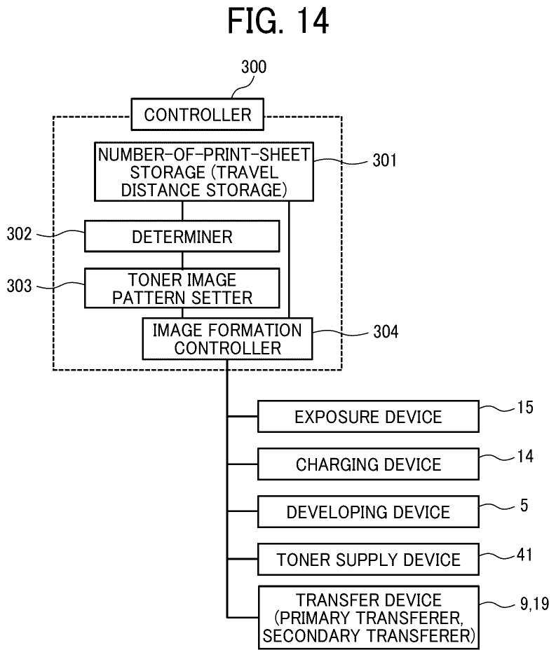

The detection result of the toner density of the developer by the toner density sensor 155 is sent as an electric signal to a controller 300 (see FIG. 14) to be described below.

The controller 300 converts an output voltage from the toner density sensor 155 into the toner density of the developer.

The controller 300 compares the output voltage from the toner density sensor 155 with a target voltage value Vtref, which is a target value of the output voltage stored in a memory.

Then, a toner supply device 41 is driven so as to supply an amount of toner corresponding to the comparison result from the toner supply port 5c, and an appropriate amount of toner is supplied from the toner bottle 11 to the developer in the first agent storage chamber 5a (toner supply control).

Therefore, the toner density of the developer in the first agent storage chamber 5a is maintained within a predetermined range near the target toner density.

an operation at the time of forming a normal color image in the copier 500 of the present embodiment will be described below.

When a start button on a control panel is pressed with a document set on a document table of the document conveyor 3, a conveyance roller of the document conveyor 3 conveys the document from the document table onto a contact glass of the document reader 4.

The image information of the document placed on the contact glass is optically read by the document reader 4.

Specifically, the color image information of the document is read for each color separation light of RGB (red, green, blue) by a color sensor and then converted into an electrical image signal.

An image processor performs processing such as color conversion processing, color correction processing, and spatial frequency correction processing on the basis of the RGB color separation image signals to obtain color image information of yellow, magenta, cyan, and black.

The image information of each color: yellow, magenta, cyan, and black is transmitted to the writer 15.

The writer 15 emits a laser beam L based on the image information of each color toward the corresponding photoconductor 1(Y, M, C, K).

The four photoconductors 1(Y, M, C, K) rotate in the clockwise direction in FIGS. 1 and 2 (the direction of an arrow A in FIG. 2).

First, the surface of the photoconductor 1(Y, M, C, K) is uniformly charged at a portion facing the charging roller 14a of the charging device 14 (charging process).

In this way, the surface of the photoconductor 1(Y, M, C, K) has a charging potential.

Thereafter, the charged surface of the photoconductor 1(Y, M, C, K) reaches the irradiation position of the laser beam L.

In the writer, laser beams L corresponding to image signals are emitted from four light sources in correspondence with the respective colors.

The laser beams L pass through different optical paths for each color component of yellow, magenta, cyan, and black, and are emitted to the surfaces of the photoconductors 1(Y, M, C, K) to form electrostatic latent images of the colors (exposure process).

Thereafter, the surface of the photoconductor 1(Y, M, C, K) on which the electrostatic latent image of each color is formed reaches the position facing the developing device 5.

Then, the toner of each color is supplied onto the surface of the photoconductor 1(Y, M, C, K) from the developer on the developing roller 151 of the developing device 5(Y, M, C, K) that stores the developer including the toner of each color and the carrier, and the latent image on the photoconductor 1(Y, M, C, K) is developed (developing process).

The direction of conveyance of the developer by the developing roller 151 is the counterclockwise direction indicated by the arrow P.

The surface of the photoconductor 1(Y, M, C, K) after passing through the portion facing the developing device 5 reaches the portion facing the intermediate transfer belt 8. The primary transfer bias roller 9(Y, M, C, K) is installed on each facing portion so as to abut against the inner peripheral surface of the intermediate transfer belt 8.

The photoconductor 1(Y, M, C, K) and the primary transfer bias roller 9(Y, M, C, K) face each other across the intermediate transfer belt 8 to form a primary transfer nip.

At this primary transfer nip, the toner images of the respective colors formed on the photoconductors 1(Y, M, C, K) are sequentially transferred in an overlapping manner onto the intermediate transfer belt 8 (primary transfer process).

The surface of the photoconductor 1 after passing through the primary transfer nip reaches a position facing the photoconductor cleaning device 2.

Then, at the position facing the photoconductor cleaning device 2, the untransferred toner remaining on the photoconductor 1 is scraped off and collected by the cleaning blade 2a (photoconductor cleaning process).

On the surface of the photoconductor 1 that has passed through the portion facing the photoconductor cleaning device 2, the residual charge is removed by passing through a neutralizer, and a series of image formation processes on the photoconductor 1 is ended, and preparation for the next image formation operation is made.

The toner images of the respective colors on the four photoconductors 1(Y, M, C, K) are transferred in an overlapping manner, and the intermediate transfer belt 8 carrying the color toner image moves on the surface in the counterclockwise direction in FIG. 1 and reaches the secondary transfer nip, which is the position facing the secondary transfer bias roller 19.

The transfer sheet P fed by the sheet feeding roller 27 from the sheet feeding tray 26 storing the transfer sheet P passes through a conveyance guide, is guided to the registration roller pair 28, abuts on the registration roller pair 28, and is once stopped.

The transfer sheet P abutting on the registration roller pair 28 is conveyed toward the secondary transfer nip in accordance with the timing at which the color toner image on the intermediate transfer belt 8 moves toward the secondary transfer nip.

Then, the color toner image carried on the intermediate transfer belt 8 at the secondary transfer nip is transferred onto the transfer sheet P (secondary transfer process).

The surface of the intermediate transfer belt 8 that has passed through the secondary transfer nip reaches a portion facing an intermediate transfer belt cleaning device 30.

At this facing portion, the transfer residual toner attached to the intermediate transfer belt 8 is collected by a cleaning blade 31 to the intermediate transfer belt cleaning device 30, and a series of transfer processes on the intermediate transfer belt 8 ends.

The untransferred toner scraped off by the cleaning blade 2a from the surface of the photoconductor 1 is stored in a waste toner container through a collected toner conveyance path.

The untransferred toner scraped off from the surface of the intermediate transfer belt 8 by the intermediate transfer belt cleaning device 30 and the toner of a pattern image for process control are also stored in the waste toner container through the collected toner conveyance path.

The transfer sheet P to which the color toner image has been transferred at the secondary transfer nip is guided to the fixing device 20.

In the fixing device 20, the color image is fixed on the transfer sheet P by heat and pressure at a fixing nip formed by a fixing roller and a pressure roller.

The transfer sheet P having passed through the fixing device 20 is discharged as an output image to the outside of the printer 100 by a sheet ejection roller pair 25 and stacked on the output tray 32, and a series of image formation processes is completed.

Above the intermediate transfer unit 10, the toner bottles 11(Y, M, C, K) as four toner containers individually storing a Y toner, a C toner, a M toner, and a K toner are disposed.

In the present copier 500, control called process control is performed at a predetermined timing in order to stabilize the image quality in the case of environmental changes or a lapse of time.

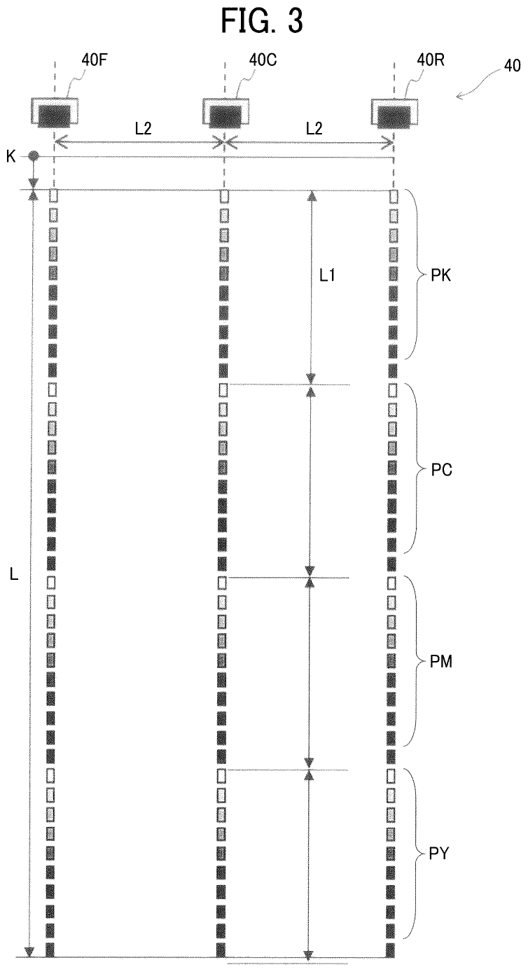

FIG. 3 is a schematic diagram illustrating a gradation pattern on the intermediate transfer belt.

The gradation pattern includes multiple toner patches having different image densities, and the gradation patterns are formed at positions (width direction center and both ends) of the intermediate transfer belt 8 facing an optical sensor unit 40.

In the example illustrated in FIG. 3, gradation patterns of black, cyan, magenta, and yellow are formed from above.

The optical sensor unit 40 includes optical sensors 40R, 40C, and 40F as multiple attachment amount sensors arranged at intervals in a belt width direction of the intermediate transfer belt 8.

Each optical sensor outputs a signal corresponding to the light reflectance of the intermediate transfer belt 8 or gradation patterns PK, PC, PM, and PY on the intermediate transfer belt 8, and detects the toner attachment amount.

The copier 500 adjusts image formation conditions such as developing bias Vb based on the detected toner attachment amount.

The optical sensors 40R and 40F disposed to face end regions in the width direction of the intermediate transfer belt 8 are arranged outside a sheet passing region.

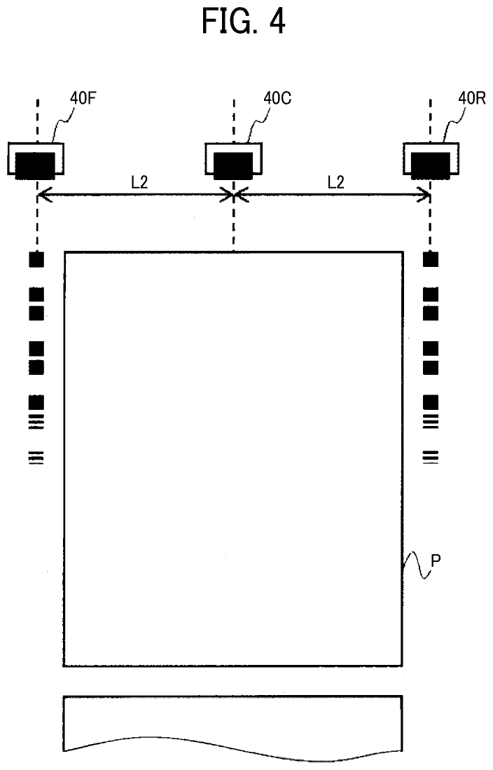

Therefore, as illustrated in FIG. 4, during formation of the toner image to be transferred to the transfer sheet, an image adjustment pattern is formed outside the sheet passing region, and the toner attachment amount of the image adjustment pattern is sensed by the optical sensors 40R and 40F.

Then, the image density and the like can be adjusted by adjusting the developing bias and the like based on the toner attachment amount sensed by the optical sensors 40R and 40F.

A base component of the toner, silica or titanium oxide added to the toner, and other materials so-called external additives of the toner are transferred from the photoconductor 1 to the intermediate transfer belt 8.

The external additive of the toner transferred to the intermediate transfer belt 8 adheres to the intermediate transfer belt 8, and filming may occur on the intermediate transfer belt 8.

In a case where the lubricant supply device 13 that applies a lubricant to the surface of the photoconductor 1 is provided, various components such as boron nitride and zinc stearate contained in the lubricant are also transferred from the photoconductor 1 to the intermediate transfer belt 8 in addition to the external additive of the toner.

Then, the external additive of the toner and the lubricant interact with each other, and filming of the intermediate transfer belt 8 may deteriorate.

At the secondary transfer nip, paper dust may transfer from the transfer sheet P to the intermediate transfer belt 8, and adhere to the intermediate transfer belt 8 to cause paper dust filming.

In recent years, the problem of intermediate transfer belt filming has been significant due to an increase in life and speed of image forming apparatuses.

Such filming of the intermediate transfer belt 8 is caused by adhesion of filming substances such as toner external additives such as silica and various components contained in the lubricant by external pressure (mainly contact pressure with the photoconductor drum) to the intermediate transfer belt 8.

When the filming occurs on the intermediate transfer belt 8, when a full-solid image or a halftone image is output, no toner is placed on a portion corresponding to the filming, and an abnormal image such as a so-called white spot that appears white occurs.

When filming occurs, the glossiness of the belt decreases.

Therefore, when filming occurs in a region of the intermediate transfer belt 8 facing the optical sensors 40R, 40C, and 40F, an output signal changes, and the attachment amount of the gradation pattern on the intermediate transfer belt cannot be favorably sensed.

There is also a problem that the output of the optical sensor is not stable and the image cannot be correctly adjusted due to the unevenness of the filming state.

The cleaning performance of the cleaning blade 31 may deteriorate due to the filming.

In the belt width direction, a gradation pattern having a large attachment amount per unit area is often input to positions of the cleaning blade 31 corresponding to the disposition positions of the optical sensors 40R, 40C, and 40F.

Therefore, when filming occurs in the regions of the intermediate transfer belt 8 facing the optical sensors 40R, 40C, and 40F, a risk of occurrence of a cleaning failure (toner slip-through) increases when the gradation pattern is input to the cleaning blade 31.

The filming is scraped off by the toner staying at the contact portion between the cleaning blade 31 and the surface of the intermediate transfer belt 8 (hereinafter referred to as “cleaning portion”), and can be removed from the surface of the intermediate transfer belt 8.

Specifically, the filming on the surface of the intermediate transfer belt is scraped off by the unevenness of the surface of the toner staying at the cleaning portion and the pressure of the cleaning blade 31 applied to the toner.

Therefore, in order to reduce the filming of the intermediate transfer belt 8, the copier 500 forms, on the photoconductor 1, a toner pattern (referred to as an input toner pattern) to be primarily transferred to the intermediate transfer belt 8 and not transferred to the transfer sheet P but input to the cleaning blade 31 in order to supply toner for scraping onto the intermediate transfer belt 8 at a predetermined timing.

By inputting this input toner pattern to the cleaning blade 31, a sufficient amount of toner stays at the cleaning portion.

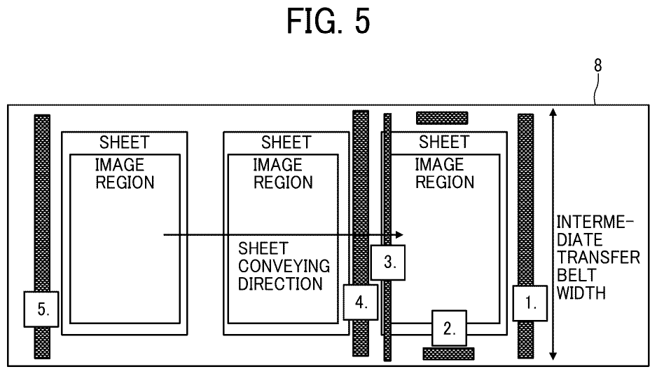

FIG. 5 is a diagram illustrating a formation position of an input toner pattern on the intermediate transfer belt.

FIG. 5 illustrates a case where three sheets are continuously printed in a normal image forming operation.

As illustrated in FIG. 5, examples of the formation position of the input toner pattern include 1. A position before the first transfer sheet to the secondary transfer nip, 2. A position outside the width of the transfer sheet passing through the secondary transfer nip, 3. A position of a non-image forming region at the rear end of the transfer sheet passing through the secondary transfer nip, 4. A position between the sheets, and 5. A position after the final sheet passes through the secondary transfer nip.

Regarding 2. above, it can be adopted in a configuration in which the width of the intermediate transfer belt is wider than an axial length of a secondary transfer roller, and the secondary transfer roller does not contact the intermediate transfer belt 8 at the position of 2. above.

This is because when the secondary transfer bias roller 19 is in contact with the intermediate transfer belt 8 at the position of 2. above, the input toner pattern formed at the position of 2. above is transferred to the secondary transfer bias roller 19.

Since the filming can be removed at the end in the width direction of the intermediate transfer belt at the position of 2. above, it is necessary to perform combination with band-shaped input toner patterns elongated in the width direction of the intermediate transfer belt of 1 and 3 to 5 above.

Regarding 3. above, the formation position may be in the non-image forming region at the leading end of the transfer sheet passing through the secondary transfer nip.

Regarding 1 and 3 to 5 above, when the input toner pattern on the intermediate transfer belt passes through the secondary transfer nip, a bias having a positive polarity is applied to a facing roller 18.

By applying the bias having a positive polarity to the facing roller 18, the input toner pattern is electrostatically attracted to the intermediate transfer belt 8, and the input toner pattern is prevented from being transferred to the secondary transfer bias roller 19 or the transfer sheet P. That is, the controller 300 functioning as a toner input controller controls the transferor to turn off the secondary transfer bias so as not to transfer the input toner pattern on the intermediate transfer belt to the transfer sheet P.

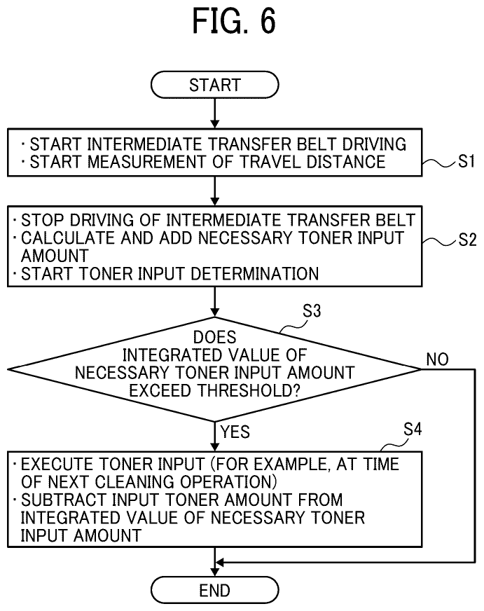

FIG. 6 illustrates an example of a flowchart of formation of the input toner pattern.

When a controller 300 (see FIG. 14) that performs various controls in the copier 500 starts driving the intermediate transfer belt 8 in response to a print command, the controller starts measuring the travel distance of the intermediate transfer belt 8 (S1).

When the driving of the intermediate transfer belt 8 is stopped, the necessary toner input amount to the cleaning blade 31 based on the filming situation on the surface of the intermediate transfer belt 8 is calculated based on the measured travel distance of the intermediate transfer belt 8.

Specifically, the necessary toner input amount is calculated by multiplying the travel distance of the intermediate transfer belt 8 by a coefficient.

Then, the calculated necessary toner input amount is added to calculate an integrated value of the necessary toner input amount (S2).

Next, the controller determines whether the integrated value of the necessary toner input amount exceeds a threshold (S3).

When the integrated value does not exceed the threshold (No in S3), the flow of FIG. 6 ends.

When the integrated value exceeds the threshold (Yes in S3), for example, an input toner pattern is formed at the time of a cleaning operation as described below.

A toner amount of the formed input toner pattern (an input toner amount to the cleaning blade) is subtracted from the integrated value (S4).

Thus, the flow of FIG. 6 ends.

In the case where the optical sensor senses the presence or absence of filming to form the input toner pattern, even if the filming occurs outside the sensing range of the optical sensor, the filming in a region of the intermediate transfer belt other than the region facing the optical sensor is not removed until the filming occurs in the region of the intermediate transfer belt facing the optical sensor.

As a result, occurrence of an abnormal image such as a white spot due to filming may not be favorably prevented.

In the present embodiment, the input toner pattern is formed based on the travel distance of the intermediate transfer belt 8.

As a result, even if filming does not occur in the region of the intermediate transfer belt 8 facing the optical sensor, when there is a possibility that filming occurs in other regions, an input toner pattern is formed.

Therefore, the filming of the intermediate transfer belt 8 can be favorably removed as compared with the case where the input toner pattern is formed on the basis of the sensing result of the optical sensor.

The coefficient may be a constant value, or for example, the coefficient may be changed between a color image mode and a monochrome image mode.

This is because the filming may be worse in the color image mode than in the monochrome image mode.

In the color image mode, the internal temperature tends to be higher than that in the monochrome image mode due to a higher fixing setting temperature and an increase in the number of motors operated.

As the internal temperature increases, the stick-slip amount of the cleaning blade 31 increases, and the filming may deteriorate.

In a case where the lubricant supply device 13 that applies a lubricant to the surface of the photoconductor 1 is provided, in the color image mode, the amount of lubricant to be a component of the filming substance attached to the intermediate transfer belt 8 is larger than that in the monochrome mode.

Therefore, the filming may be worse in the color image mode than in the monochrome image mode.

Therefore, for example, a coefficient B of the color image mode is set to a value higher than a coefficient A of the monochrome image mode (A<B).

Then, at the time of image formation (at the time of driving the intermediate transfer belt), it is determined whether the mode is the monochrome image mode or the color image mode.

In the monochrome image mode, the necessary toner input amount is calculated using the coefficient A, and in the color image mode, the necessary toner input amount is calculated using the coefficient B.

For example, in a case where the color image mode is often used, as described above, there is a higher possibility that the filming deteriorates than in the monochrome image mode.

However, when the color image mode is often used, the integrated value of the necessary toner input amount exceeds the threshold on the basis of a short travel distance of the intermediate transfer belt 8, and thus, the input toner pattern is formed at an early timing.

When the monochrome image mode is often used, filming is less likely to deteriorate as compared with the case of the color image mode.

Therefore, when the monochrome image mode is often used, the travel distance based on which the integrated value of the necessary toner input amount exceeds the threshold becomes long, and the input toner pattern is formed at a later timing.

As described above, by forming the input toner pattern on the basis of the image mode, the input toner pattern can be formed at an appropriate timing, and wasteful toner consumption and deterioration of filming can be favorably prevented.

As described above, the filming on the surface of the intermediate transfer belt 8 can be favorably and preferably removed by a sufficient amount of toner staying at the cleaning portion.

However, when the toner amount of the input toner pattern is increased and a large amount of toner is input to the cleaning portion at a time, there is a possibility that toner slip-through occurs and a cleaning failure occurs.

The copier has multiple image forming modes in which the linear speed of the intermediate transfer belt 8 is different, such as a standard speed, a medium speed, and a low speed, and is configured to switch the image forming mode according to the sheet type, the installation environment of the image forming apparatus, and the use situation of the customer.

In the image forming mode of the standard speed, the linear speed of the intermediate transfer belt 8 is increased in order to improve the productivity, and the filming is easily deteriorated by such an increase in the speed.

As a result, in the case of the image forming mode of the standard speed, in order to favorably remove the filming on the intermediate transfer belt 8, it is necessary to increase the toner amount input to the cleaning portion as compared with the image forming mode of the medium speed or the low speed.

However, as described above, when the toner amount of the input toner pattern is increased and a large amount of toner is input to the cleaning portion at a time, a cleaning failure occurs.

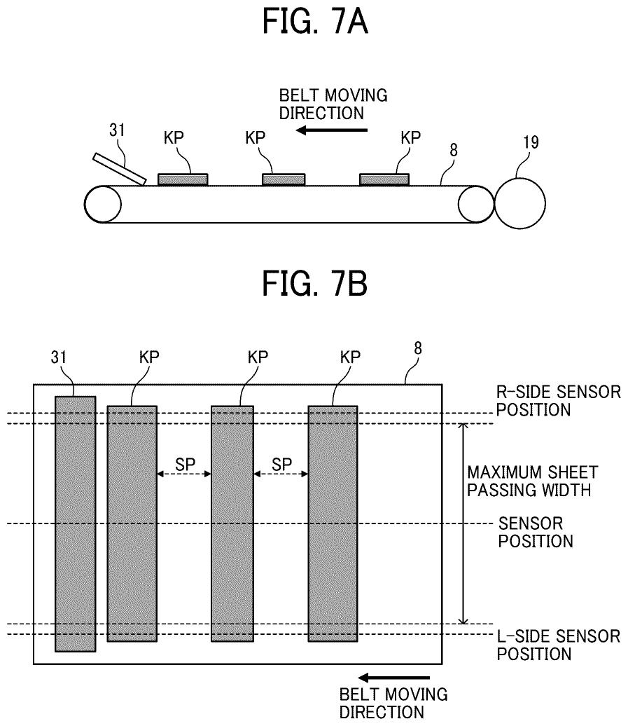

Therefore, as illustrated in FIGS. 7A and 7B, multiple input toner patterns KP are formed at short intervals.

As a result, the toner amount of the input toner patterns KP is set to the toner amount in which the cleaning failure does not occur, and the toner amount enabling favorably removing the filming on the intermediate transfer belt can be secured by the number of the input toner patterns KP.

As illustrated in FIG. 7B, each of the input toner patterns KP is a belt-like pattern elongated in a main scanning direction, is longer than the maximum sheet passing width that can be conveyed by the device, and extends in the main scanning direction to the regions facing the optical sensors 40R and 40F disposed to face each other at both ends of the intermediate transfer belt 8.

As a result, it is possible to favorably reduce filming in the maximum sheet passing width region of the intermediate transfer belt 8 on which the toner image to be transferred onto the transfer sheet P is formed, and it is possible to favorably prevent occurrence of an abnormal image such as a white spot.

The input toner patterns KP extend to the regions facing the optical sensors 40R and 40F disposed to face each other at both ends of the intermediate transfer belt 8.

Therefore, it is possible to favorably reduce the filming of the portions of the intermediate transfer belt 8 facing the optical sensors 40R and 40F, and to favorably sense the attachment amount.

Intervals Sp are set such that the next input toner pattern is input before the toner forming the preceding input toner pattern is completely removed from the cleaning portion.

The intervals Sp are set such that when the next input toner pattern KP is input to the cleaning portion, the amount of toner staying at the cleaning portion is equal to or less than the amount of toner at which a cleaning failure occurs.

Thus, the cleaning failure is prevented, and the filming is favorably reduced.

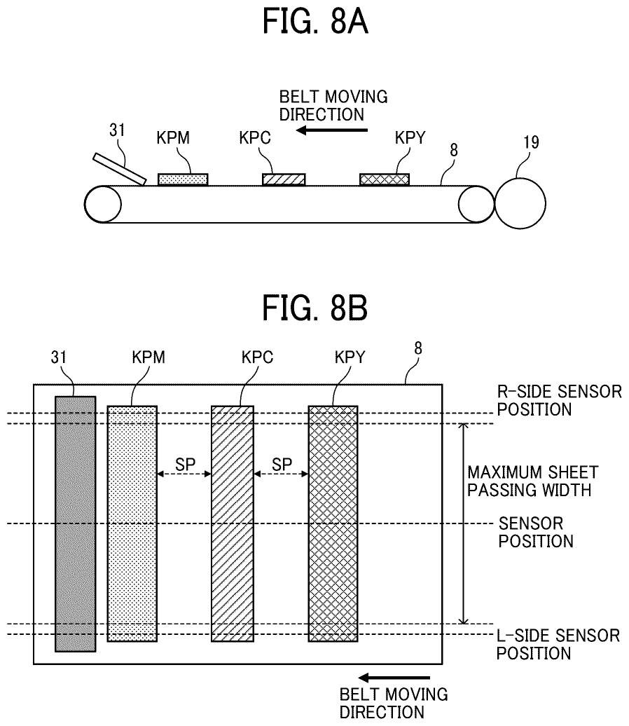

As illustrated in FIG. 8, it is preferable to form three input toner patterns with toners of different colors.

As a result, it is possible to prevent toner consumption from being biased to a specific color.

In FIGS. 8A and 8B, the input toner pattern on the most downstream side of the intermediate transfer belt 8 is C color, the input toner pattern on the center is M color, and the input toner pattern on the most upstream side is Y color, which follows the arrangement order of the image forming units 6 illustrated in FIG. 1.

As described above, by causing the order of colors of the input toner patterns to follow the arrangement order of the image forming units 6, the image formation time for forming the three input toner patterns can be shortened.

An example of each dimension in a sub-scanning direction is as described below.

The C-color input toner pattern is 70 mm, the M-color input toner pattern is 60 mm, the Y-color input toner pattern is 70 mm, and two SPs are 80 mm.

The three input toner patterns in the order of K, C, and M colors may be formed on the intermediate transfer belt 8.

Even with such a configuration, for example, the image formation time for forming the three input toner patterns can be shortened in the order of K, M, and Y as compared with the case where the C color is skipped.

The image formation time is a time from when one of the three image formers starts the above-described series of image formation processes to when the last one of the three image formers ends the above-described series of image formation processes.

As illustrated in FIGS. 7A, 7B, 8A, and 8B, by forming multiple input toner patterns KP at short intervals, it is possible to prevent a cleaning failure and favorably remove filming in the image forming mode of the standard speed in which filming is likely to deteriorate.

However, in the image forming modes of the medium speed and the low speed, since the linear speed of the intermediate transfer belt 8 is slower than that in the image forming mode of the standard speed, the filming level is lower than that in the image forming mode of the standard speed.

Therefore, when multiple input toner patterns KP is formed in the image forming modes of the medium speed and the low speed as illustrated in FIGS. 7A, 7B, 8A, and 8B, the amount of toner to be input to the cleaning portion is excessive with respect to the state of filming, and the toner consumption amount is unnecessarily increased.

Therefore, the number of the input toner patterns KP in the image forming modes of the medium speed and the low speed is preferably smaller than that in the image forming mode of the standard speed.

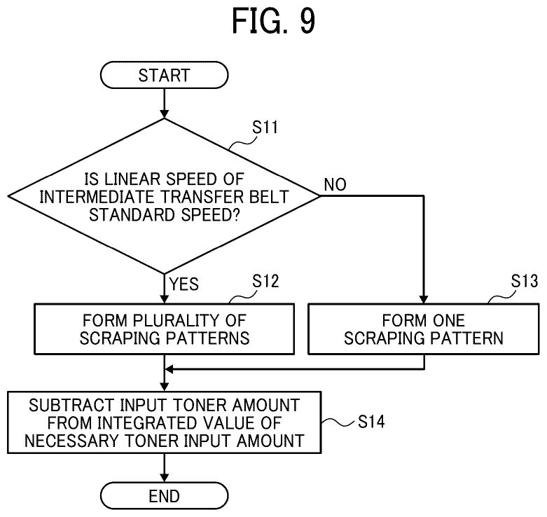

FIG. 9 is a flowchart related to formation of the input toner pattern KP of the present embodiment.

As described with reference to FIG. 5, when the integrated value of the necessary toner input amount exceeds the threshold and it is time to form the input toner pattern, the controller 300 checks whether the setting linear speed of the intermediate transfer belt 8 is the standard speed (S11). The image forming mode is a condition associated with the linear speed of the image forming apparatus.

When the image forming mode is the image forming mode of the standard speed and the linear speed of the intermediate transfer belt 8 is set to the standard speed (high speed) (Yes in S11), as illustrated in FIGS. 7A, 7B, 8A, and 8B, multiple input toner patterns KP is formed at short intervals (S12).

When the image forming mode is the image forming mode of the medium speed or the low speed, and the linear speed of the intermediate transfer belt 8 is set to the medium speed or the low speed (No in S11), one input toner pattern KP is formed (S13).

The toner amount of the formed input toner pattern (input toner amount to the cleaning blade) is subtracted from the integrated value (S14).

As described above, one input toner pattern KP is provided in the image forming mode of the medium speed or the low speed in which the deterioration of the filming is moderate as compared with the case in the image forming mode of the standard speed.

Even when the number of input toner patterns KP is one and the amount of toner input to the cleaning portion is small, filming of the intermediate transfer belt 8 can be favorably removed.

Accordingly, wasteful toner consumption can be reduced.

The threshold of the integrated value of the necessary toner input amount for determining whether to form the input toner pattern described with reference to FIG. 6 may be different between the image forming mode of the standard speed and the image forming modes of the medium speed and the low speed.

Specifically, the threshold in the image forming mode of the standard speed may be set to be lower than the threshold in the image forming modes of the medium speed and the low speed, and the formation frequency of the input toner pattern may be increased in the image forming mode of the standard speed as compared with the image forming modes of the medium speed and the low speed.

As described with reference to FIG. 6, the necessary toner input amount is calculated by multiplying the travel distance of the intermediate transfer belt 8 by the coefficient, but the coefficient may be changed between the image forming mode of the standard speed and the image forming modes of the medium speed and the low speed.

Specifically, the value of the coefficient in the image forming mode of the standard speed is made larger than the value of the coefficient in the image forming modes of the medium speed and the low speed.

As a result, in the image forming mode of the standard speed, the formation frequency of the input toner pattern can be increased as compared with the image forming modes of the medium speed and the low speed, and the deterioration of the filming in the image forming mode of the standard speed can be prevented.

As described above, the lubricant attached to the intermediate transfer belt 8 is one factor that deteriorates filming on the intermediate transfer belt 8, but there is an advantage that the friction coefficient of the surface of the intermediate transfer belt with respect to the cleaning blade 31 is lowered to prevent the tip of the cleaning blade 31 from being curled.

In particular, since the transfer residual toner does not come to both ends of the cleaning blade 31 facing the outside of the image forming region on the intermediate transfer belt, the transferred lubricant component and the scumming toner reduce the frictional force between the intermediate transfer belt 8 and the cleaning blade 31, thereby preventing the occurrence of blade-curling (hereinafter, referred to as blade-curling).

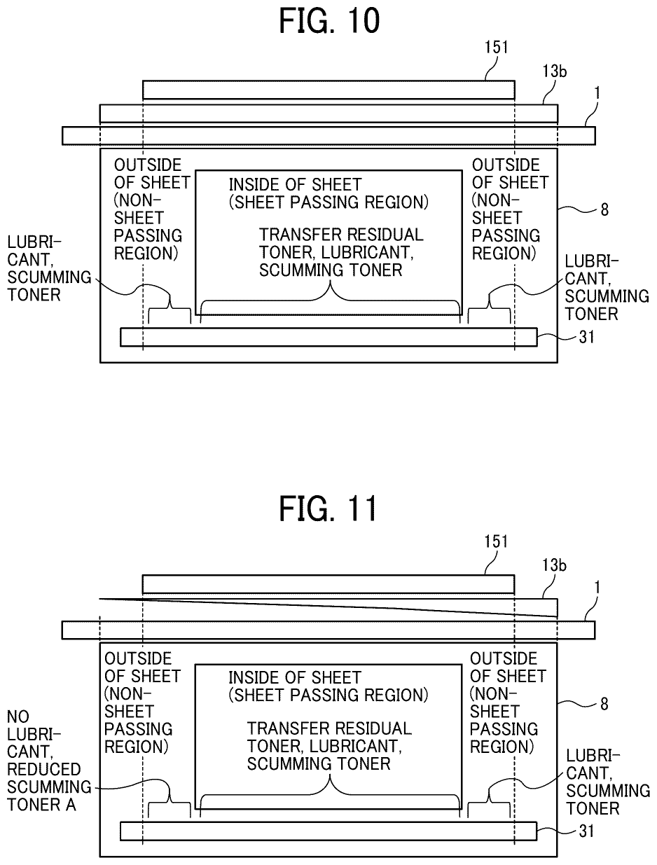

As illustrated in FIG. 10, in a case where a solid lubricant 13b of the lubricant supply device 13 is present, the transfer residual toner, the lubricant, and the scumming toner are input to a portion of the cleaning blade 31 that abuts on the sheet passing region of the intermediate transfer belt 8.

The lubricant and the scumming toner are continuously input to a portion abutting on a non-sheet passing region.

Therefore, when the solid lubricant 13b of the lubricant supply device 13 is present, the tip of the cleaning blade 31 is favorably prevented from being curled, and abnormal wear of the tip of the cleaning blade 31 is prevented.

As the image forming operation is repeatedly performed, the solid lubricant 13b is scraped over time, and the size of the solid lubricant 13b decreases.

Since the image forming unit 6 has been replaced with a new image forming unit 6 before running out of the solid lubricant 13b when it is determined that the image forming unit 6 has reached its end of life, and thus the blade-curling has not occurred.

With the recent increase in environmental awareness, the image forming unit 6 is used up until running out of the lubricant.

In such a situation, the image forming operation may be continuously performed in a state of running out of the lubricant around the photoconductor, and the image forming operation may be continued in a state where the lubricant has not transferred to the intermediate transfer belt 8.

In this case, the lubricant component does not come to both ends of the cleaning blade facing the outside of the image forming region on the transfer belt, so that the curling is likely to occur.

As a result of studies by the inventors, it has been found that the surface of the photoconductor to which the lubricant is not applied has better chargeability and the scumming toner amount decreases as compared with the surface of the photoconductor to which the lubricant is applied.

When the lubricant around the photoconductor is depleted, both the lubricant component and the scumming toner amount having a role of reducing the frictional force between the cleaning blade 31 and the intermediate transfer belt 8 are reduced.

Since the lubricant component is not interposed between the cleaning blade and the transfer belt, and the scumming toner amount is also reduced, the frictional force between the cleaning blade and the transfer belt is increased in the sheet outer region, and the blade-curling is likely to occur.

FIG. 11 is a diagram illustrating a case where the solid lubricant 13b is depleted.

The solid lubricant 13b is urged toward a lubricant supply roller 13a by compression springs 13c on one end side and the other end side in a longitudinal direction (width direction of the device) of the solid lubricant 13b, but due to the uneven urging force between the compression springs 13c, as illustrated in FIG. 11, one side (left side in the drawing) in the longitudinal direction is depleted more quickly than the other side (right side in the drawing).

Therefore, in the non-sheet passing region on the lubricant depletion side of the intermediate transfer belt 8, the attachment amount of the lubricant decreases.

The scumming toner supplied from the developing device 5 also decreases.

As a result, the frictional force with the intermediate transfer belt 8 increases on the lubricant depletion side of the cleaning blade 31, and the tip may be curled on the lubricant depletion side of the cleaning blade 31.

The occurrence of the blade-curling leads to a serious defect such as stop of the image forming operation or breakage of the intermediate transfer belt 8.

If maintenance such as replacement of the image forming unit 6 or replacement of the solid lubricant 13b is performed before the lubricant is depleted as in the conventional case, there is also a disadvantage that resources are wasted and inefficiency such as downtime of customer operations occurs.

In particular, in recent years, from the viewpoint of waste reduction along with the increase in environmental awareness, there is a case where the image forming unit 6 is continuously used without being replaced for a certain period until the lubricant disappears or even after the lubricant disappears.

In this case, when the blade is curled and the blade-curling occurs, the intermediate transfer belt is often broken in addition to the breakage of the cleaning blade, and it takes a long time to recover the image forming apparatus, which causes a big disadvantage that the downtime of the customer is increased.

Therefore, in the present embodiment, in order to eliminate waste of resources due to replacement of the image forming unit 6 at an early stage before the lubricant is depleted and to eliminate inefficiency due to maintenance, even when the lubricant is depleted, blade-curling is prevented from occurring immediately.

Therefore, even in a case where the solid lubricant 13b mounted on the image forming unit 6 is depleted, blade-curling is prevented by increasing the toner input amount of the toner image pattern to be input to the cleaning blade 31 that cleans the surface of the intermediate transfer belt 8 without transfer to the recording medium at least outside the image forming region after reaching a threshold number of printed sheets or a threshold travel distance over time after the image forming operation is repeatedly performed, as compared with before reaching the threshold number of printed sheets or the threshold travel distance.

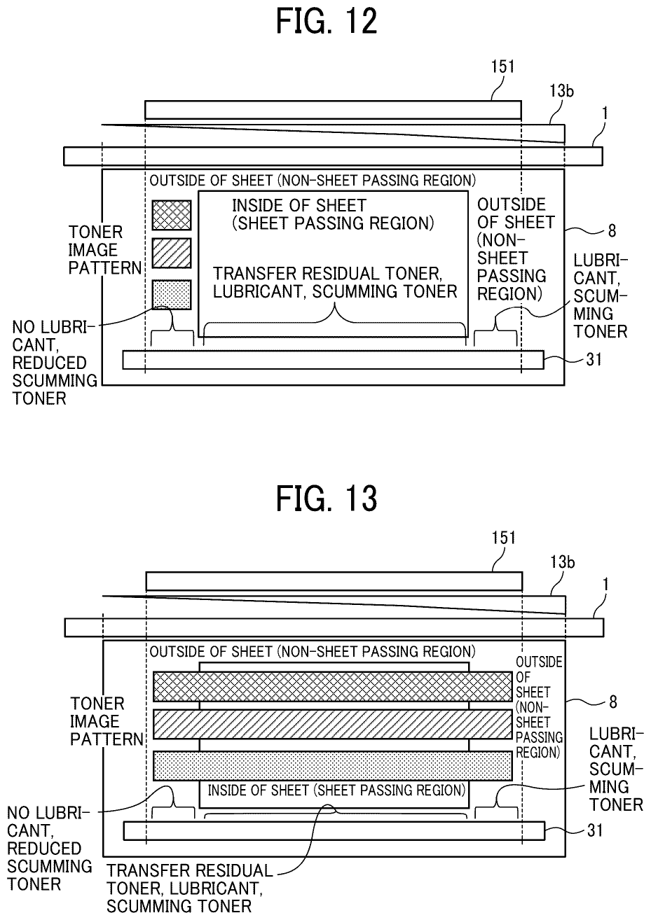

FIG. 12 is a diagram illustrating an input toner pattern for increasing a toner input amount for preventing the cleaning blade 31 from being curled due to lubricant depletion.

As illustrated in FIG. 12, a state is illustrated in which more toner image patterns are input outside the image forming region (sheet outer region) at the end of the cleaning blade 31 where lubricant depletion has occurred in the main scanning direction than before a setting value is reached to prevent the curling.

As a result, on the lubricant depletion side of the cleaning blade 31, it is possible to improve the slippage with the intermediate transfer belt 8 by the toner dammed by the cleaning blade 31, and it is possible to prevent the tip of the cleaning blade 31 from being curled.

It is not clear which one of the one end side and the other end side in the longitudinal direction of the solid lubricant 13b is depleted quickly unless a special means is used.

In this case, at the timing when the solid lubricant 13b is depleted and reaches the end of life, the input toner patterns are formed (primary transfer) in the non-sheet passing region on both sides of the intermediate transfer belt 8.

For example, in a case where it is possible to determine which one in the longitudinal direction is depleted or is to be depleted quickly using the outputs of the optical sensor 40F and the optical sensor 40R, it is also possible to form the pattern on the corresponding side.

As described above, the controller 300 changes the input toner pattern from the band-shaped pattern to a combination of the band-shaped pattern and the end pattern formed at 2. “the position outside the width of the transfer sheet passing through the secondary transfer nip” in FIG. 5 at the timing when the solid lubricant 13b of one image former of the multiple image formers reaches the end of life.

That is, more toner image patterns are input to the portion where the solid lubricant 13b disappears than before the solid lubricant 13b disappears.

As a result, the toner amount in a predetermined period input to the non-sheet passing region of the cleaning blade 31 (portion of the intermediate transfer belt 8 in contact with the non-sheet passing region) increases.

As a result, it is possible to compensate for the shortage of the scumming toner, and it is possible to prevent the tip of the cleaning blade 31 from being curled.

As described above, in the present embodiment, the controller 300 functions as a pattern changer.

FIG. 13 is a diagram illustrating a modification of the input toner pattern for preventing the cleaning blade 31 from being curled due to lubricant depletion.

The case where the toner image pattern is input not to the portion where the solid lubricant 13b disappears but also to the entire region in the main scanning direction. Similarly to FIG. 12, the frictional force between the cleaning blade 31 and the intermediate transfer belt 8 is reduced instead of the lubricant that does not enter due to the disappearance of the solid lubricant 13b and the scumming toner, so that the blade-curling is not generated.

In the present embodiment, the determination as to whether it is the timing at which the solid lubricant 13b reaches the end of life is performed as described below.

The fact that the solid lubricant 13b reaches the end of life means that the solid lubricant 13b decreases to such an extent that a non-supply portion A where the lubricant is not supplied is present on the surface of the intermediate transfer belt 8 as described with reference to FIG. 11.

In the present embodiment, it is determined that the solid lubricant 13b is depleted when the travel distance of the image bearer in which the lubricant is assumed to disappear in advance, the number of printed sheets, or both of them reach predetermined setting values.

This will be specifically described below.

It is determined that the solid lubricant 13b is depleted, and the toner input amount is made larger than that before the setting value is reached.

By inputting more toner image patterns to the portion where the solid lubricant 13b has disappeared than before reaching the setting value, the frictional force between the cleaning blade 31 and the transfer belt is reduced instead of the lubricant that does not enter due to the disappearance of the solid lubricant 13b and the scumming toner, so that the belt-curling is not generated.

The determination as to whether the solid lubricant 13b is depleted is basically the same as whether the determination is made based on the travel distance or the number of printed sheets. Therefore, the determination will be described below based on the number of printed sheets.

Another example of the setting value of the number of printed sheets of the image bearer with which the lubricant is assumed to disappear is as described below.

When the set life of the image forming unit 6 is, for example, 500,000 sheets, an abnormal image caused by the image forming unit 6 does not appear up to 500,000 sheets.

The lifetime of the image forming unit 6 is set in consideration of usage by the customer.

The usage includes the number of printed sheets by one print instruction, the total number of printed sheets per day, a temperature and humidity environment in which printing is performed, a ratio between a monochrome image and a color image, and an image area ratio.

Although the life of the parts of the image forming unit 6, such as the photoconductor, the charging roller, the cleaning blade 31, the solid lubricant 13b, and the lubricant application blade, also changes depending on the usage, the image forming unit 6 is designed assuming the usage by a certain standard customer so that the abnormality caused by such a part does not occur within at least 500,000 sheets when the life of the image forming unit 6 is set to 500,000 sheets.

Therefore, in a case where the life of the image forming unit 6 is set to 500,000, the solid lubricant 13b is also designed such that one end of the solid lubricant 13b does not disappear within 500,000 sheets in the assumed usage by the customer.

Therefore, in a case where the life of the image forming unit 6 is 500,000 sheets, when the setting value of the number of printed sheets for which it is determined that the lubricant is depleted is set to be the same as the life of the image forming unit 6, i.e., 500,000 sheets, the toner input amount is actually increased before the solid lubricant 13b is depleted at the time of 500,000 sheets, and thus, it is possible to prevent the timing of increasing the toner input amount from being after the solid lubricant 13b is depleted.

Next, a method of increasing the toner input amount when the number of printed sheets for which it is determined that the lubricant has disappeared will be described.

In the image forming apparatus of the present disclosure, a lubricant application member that supplies the lubricant to the image forming unit 6 is provided in order to prolong the life of the entire circumference of the photoconductor.

Therefore, the lubricant component is transferred to and adheres to the intermediate transfer belt 8 on the downstream side, so that so-called filming occurs, and a problem of an abnormal image and a cleaning failure occurs.

In order to prevent filming on the transfer belt, toner is discharged before a job or after a process control operation (adjustment operation), and a toner image pattern that is not transferred to a sheet is input to the cleaning blade 31 to prevent filming.

Therefore, when the number of printed sheets of the image bearer reaches a predetermined setting value, the toner input amount is made larger than that before the setting value is reached by utilizing the toner input control originally performed for preventing filming.

In the toner image pattern input for preventing filming, there is a method of increasing the length of one toner image pattern in an image bearer moving direction to increase the amount of toner input to the cleaning blade 31 at a time.

There is a method of increasing the toner attachment amount of one toner image pattern to increase the toner amount input to the cleaning blade 31 at a time.

In a proposed method, toner is input after the process control operation, and the process control operation is performed, for example, once every 200 sheets before the setting value is exceeded. After the setting value is exceeded, the frequency of the process control operation is increased to, for example, once every 100 sheets to increase the frequency of toner input from once every 200 sheets to once every 100 sheets, thereby increasing the amount of toner input.

Alternatively, there is a method of increasing the toner input amount by performing toner input at a frequency of, for example, every 50 printed sheets, every 100 printed sheets, or the like, separately from the filming prevention control when the number of printed sheets reaches a predetermined setting value.

Among the above methods, there is a method of increasing the input toner amount by combining two or more of the above methods.

When the speed of the device is increased (the number of printed sheets per unit time is increased), filming of the transfer belt is likely to deteriorate, and thus, it is necessary to increase the input toner amount for preventing filming. However, when the amount of input toner entering at a time is large, a cleaning failure may occur.

In order to enhance the effect of preventing filming when the speed of the device is increased, originally, multiple toner image patterns with a predetermined interval in which a toner image is not input between the toner image pattern and the toner image pattern can be input as the toner image pattern that does not cause a cleaning failure while increasing the total amount of toner input to the cleaning blade 31.

Therefore, in a case where the number of printed sheets of the image bearer reaches a predetermined setting value, the toner input amount can be made larger than that before the setting value is reached by utilizing the input control of the multiple toner image patterns provided with a predetermined interval originally performed for preventing filming.

There is a method of increasing the toner input amount by increasing the length of each toner image pattern in the image bearer moving direction in multiple toner image patterns provided with a predetermined interval input for preventing filming.

There is a method of increasing the number of toner image patterns formed at predetermined intervals to increase the toner input amount.

There is a method of increasing the toner attachment amount of each toner image pattern to increase the toner input amount.

In a proposed method, toner is input after the process control operation, and the process control operation is performed, for example, once every 200 sheets before the setting value is exceeded. After the setting value is exceeded, the frequency of the process control operation is increased to, for example, once every 100 sheets to increase the frequency of toner input from once every 200 sheets to once every 100 sheets, thereby increasing the amount of toner input.

Alternatively, there is a method of increasing the toner input amount by performing toner input at a frequency of, for example, every 50 printed sheets, every 100 printed sheets, or the like, separately from the filming prevention control when the number of printed sheets reaches a predetermined setting value.

Among the above methods, there is a method of increasing the toner input amount by combining two or more of the above methods.

Next, another example of the method of increasing the toner input amount when the number of printed sheets for which it is determined that the lubricant has disappeared is reached will be described.

The occurrence of curling of the cleaning blade 31 is closely related to the internal temperature and the image formation linear speed (moving speed of the image bearer).

The inventors acknowledge that, when the internal temperature of the image forming apparatus or the temperature in the vicinity of the cleaning blade 31 is high, the curling easily occurs, and when the internal temperature or the temperature in the vicinity of the cleaning blade 31 is low, the curling does not easily occur.

Therefore, after reaching the number of printed sheets for which it is determined that the lubricant has disappeared, the amount of increase in the toner input amount is changed according to the internal temperature or the temperature in the vicinity of the cleaning blade 31. The temperature inside the apparatus is a condition according to which the toner input amount is adjusted.

In a case where the internal temperature or the temperature in the vicinity of the cleaning blade 31 is low, the risk of occurrence of curling is relatively low as compared with a case where the temperature is high. Therefore, the toner input increase amount is relatively reduced as compared with a case where the temperature is high.

With such control, it is possible to prevent a large amount of toner from being unnecessarily input and to prevent an increase in the toner consumption amount.

It is known that when the image formation linear speed of the image forming apparatus is fast (for example, 300 mm/s), the curling easily occurs, and when the image formation linear speed is slow (256 mm/s), the curling does not easily occur.

In a case where the image formation linear speed is low, the risk of occurrence of curling is relatively low as compared with a case where the image formation linear speed is high. Therefore, the toner input increase amount is relatively small as compared with a case where the linear speed is high.

With such control, it is possible to prevent a large amount of toner from being unnecessarily input and to prevent an increase in the toner consumption amount.

Next, description will be given of using the number of printed sheets of a Bk image forming unit 6K as an image forming unit to be subjected to lifetime determination of the image forming apparatus in which the Bk image forming unit using the black toner and the image forming unit using the color toner face the common intermediate transfer belt 8.

In the device of the present disclosure, image forming units 6 of four colors: Bk, C, M, and Y are mounted.

In the case of monochrome image printing, the Bk image forming unit 6K basically operates, and in the case of color image printing, the four image forming units 6 of Bk, C, M, and Y operate.

Since the four image forming units 6 operate during the color image printing, the lubricants of the solid lubricants 13b for the four units are transferred to the transfer belt.

During monochrome image printing, since one Bk image forming unit 6K operates, the lubricant of the solid lubricant 13b for the one unit is transferred to the transfer belt.

¼ of the lubricants is transferred during the monochrome image printing as compared with that during the color image printing.

From the viewpoint of transfer belt filming, it is advantageous for filming during monochrome image printing, but from the viewpoint of blade-curling, it is disadvantageous for curling during monochrome image printing.

In a case where the lubricant of the Bk image forming unit 6K is depleted, since the Bk image forming unit 6K operates during monochrome image printing, there is no lubricant transfer from the C, M, and Y image forming units 6 to the transfer belt, and there is no lubricant transfer to the transfer belt, and thus, the blade-curling occurs.

Even in a case where the lubricant of the Bk image forming unit 6K is depleted, there is lubricant transfer from the C, M, and Y image forming units 6 to the transfer belt during color image printing, and thus, the blade-curling does not occur.

As a result, the transfer of the lubricant to the transfer belt is completely eliminated, and the blade-curling is likely to occur during the monochrome image printing in the Bk mode when the lubricant of the Bk image forming unit 6K is depleted.

Therefore, when it is determined that the lubricant has disappeared on the basis of the number of printed sheets of the Bk image forming unit 6K and the threshold number of printed sheets has been reached, the blade-curling can be prevented by increasing the toner input amount.

A block diagram and a flowchart will be described for control of increasing the input toner amount by changing the toner image pattern setting according to the number of printed sheets or the travel distance of the photoconductor 1.

FIG. 14 is a block diagram related to “setting of toner image pattern” input to the cleaning blade 31 that cleans the surface of the intermediate transfer belt 8 without transfer to the recording medium.

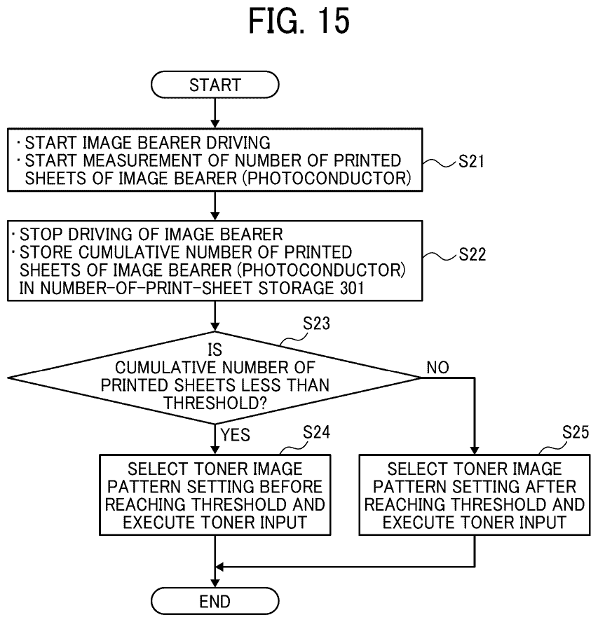

FIG. 15 is a flowchart.

As illustrated in FIG. 14, the functional units implemented by the controller 300 includes a number-of-print-sheet storage 301 that stores at least the number of printed sheets of the image bearer (photoconductor 1), a determiner 302 that determines whether the solid lubricant 13b has reached its end of life, a toner image pattern setter 303, and an image formation controller 304.

As described above, the travel distance of the image bearer (photoconductor 1) may be counted instead of the number of printed sheets.

The controller 300 is, for example, a controller board on which a circuit for controlling the copier 500 is mounted.

For example, the circuit that comprehensively controls the copier 500 includes a central processing unit (CPU), a random-access memory (RAM), and a read-only memory (ROM).

In the controller 300, the CPU executes programs stored in the ROM or a hard disk drive (HDD) using the RAM as a work area, to implement the above-described functional units.

The control panel may be controlled by the controller 300, or a control circuit other than the controller 300 for controlling the control panel may be used.

In this case, the control circuit of the controller 300 and the control circuit of the control panel are connected to communicate with each other, and the controller 300 controls the entire copier 500 including the control panel.

The number-of-print-sheet storage 301 counts how much the photoconductors 1 of K, C, M, and Y colors have been used from the start of use of the image forming units 6 to the present in terms of the number of printed sheets (steps 1 and 2 in FIG. 15).

Since the number of printed sheets of the photoconductor 1 indicates how much amount of the solid lubricant 13b has been ground by the lubricant supply roller 13a in terms of the number of printed sheets, the number of printed sheets becomes an index for estimating the remaining amount of the solid lubricant 13b.

The determiner 302 compares the cumulative number of printed sheets from the start of use to the present with a threshold number of printed sheets (threshold), and determines whether the number of printed sheets reaches the threshold.

When the determiner 302 determines that the threshold has been reached, the toner image pattern setter 303 changes the toner image pattern setting before reaching the threshold to the toner image pattern setting after reaching the threshold so that the input toner amount after reaching the threshold is larger than that before reaching the threshold (FIG. 15, when no in step 3, step 5).

Here, increasing the input toner amount means increasing the input toner amount per unit number of printed sheets or per unit travel distance, and the setting is changed to increase the input toner amount by any of the methods described above after the threshold is reached as compared with the input toner amount before the threshold is reached.

The image formation controller 304 controls at least the writer 15, the charging device 14, the developing device 5, the toner supply device 41, a transfer device (primary transferer, secondary transferer), and the like.

Under the control of the image formation controller 304, a toner image pattern is formed on the photoconductor 1 according to the toner image pattern setting determined by the toner image pattern setter 303, the toner image pattern is transferred onto the transfer belt by the primary transferer, the toner image pattern is not transferred onto the transfer sheet by the secondary transferer, and the toner image pattern reaches the cleaning blade 31 for the transfer belt.

The controller 300 corresponds to the toner input controller.

The above embodiment can be understood as described below.

The image forming apparatus including at least a latent image bearer, a lubricant application member that supplies a lubricant to the surface of the latent image bearer, the intermediate transfer belt 8, and the cleaning blade 31 that cleans the surface of the intermediate transfer belt 8, and performs an operation of appropriately forming a toner image pattern input to the cleaning blade 31 that cleans the surface of the intermediate transfer belt 8 without transfer to a recording medium on the intermediate transfer belt 8, wherein when at least the travel distance of the latent image bearer reaches a threshold distance, the number of printed sheets of the latent image bearer reaches a threshold number of printed sheets, or both the travel distance and the number of printed sheets reach the threshold distance and the threshold number of printed sheets, after reaching the predetermined travel distance or number of printed sheets, the toner input amount of the toner image pattern input to the cleaning blade 31 that cleans the surface of the intermediate transfer belt 8 is increased without transfer to the recording medium at least outside the image forming region as compared with before reaching the predetermined travel distance or the predetermined number of printed sheet.

According to this, the lubricant component does not enter due to the lubricant depletion, and the curling easily occurs. Therefore, the toner input amount to the blade is increased, the frictional force between the transfer belt and the cleaning blade 31 is reduced, and the blade-curling can be prevented.

It is sufficient that the image forming unit 6 can be replaced at the timing of running out of the solid lubricant 13b by providing a remaining amount sensor or the like for the solid lubricant 13b in the image forming unit 6, but providing the remaining amount sensor or the like may lead to an increase in size and cost of the device.

According to the present embodiment, without providing the remaining amount sensor or the like, a blade-curling preventor is provided separately from unit replacement before the lubricant is depleted.

Therefore, in addition to providing the lubricant remaining amount sensor or replacing the unit, it is possible to prevent the blade-curling even in a state where the lubricant is depleted.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

The effects obtained by the above-described embodiment are examples. The effects according to the present disclosure are not limited to the above-described effects.

The above description is an example, and the present disclosure has unique effects for each of the following aspects.

In the description of the aspects, reference signs in parentheses after the names of elements are examples of corresponding members, and are not limited to the examples.

### First Aspect

According to a first aspect, an image forming apparatus (500) includes: an image bearer (1) on which a toner image of an image to be formed is formed; an intermediate transferor (8) to which the toner image of the image bearer (1) is transferred; a transferor that transfers the toner image of the intermediate transferor (8) onto a recording medium; a cleaner (31) that cleans a surface after the toner image of the intermediate transferor (8) is transferred to the recording medium; a lubricant supplier (13) that supplies a lubricant to an intermediate-transferor facing member (8, 19) facing the intermediate transferor (8), including the image bearer (1); and a toner input controller (300) that forms a toner image on a surface portion of the image bearer (1) on which the image is not formed, transfers the toner image onto the intermediate transferor (8), and inputs the toner image to a contact portion of the cleaner (31), wherein a determiner (302) determines whether a non-supply portion (A) where the lubricant is not supplied via the intermediate-transferor facing member (8, 19) is present on the intermediate transferor (8) due to a decrease in the lubricant in the lubricant supplier (13), and when the determiner (302) determines that the non-supply portion (A) is present, the toner input controller (300) increases an amount of toner entering the contact portion of the cleaner (31) more than before the determiner (302) determines that the non-supply portion (A) is present on the intermediate transferor (8).

### Second Aspect

According to a second aspect, in the image forming apparatus (500) of the first aspect, the determiner (302) determines whether the non-supply portion (A) is present on the intermediate transferor (8) based on a cumulative movement amount of the surface of the intermediate-transferor facing member (8, 19) from start of use of the lubricant.

### Third Aspect

According to a third aspect, in the image forming apparatus (500) of the first aspect, the intermediate-transferor facing member (8, 19) comprises the image bearer (1), and the determiner (302) determines that the non-supply portion (A) is present on the intermediate transferor (8) in at least one of a case where a cumulative number of times of image formation from start of use of the lubricant reaches a threshold number of times and a case where a cumulative surface moving distance reaches a threshold distance.

### Fourth Aspect

According to a fourth aspect, in the image forming apparatus (500) of any one of the first to third aspects, the non-supply portion (A) is a partial portion of the surface of the intermediate transferor (8) in a direction orthogonal to the surface moving direction in which the surface of the intermediate transferor (8) moves, and the toner input controller (300) increases the amount of toner at least at a predetermined partial portion where the non-supply portion (A) is expected to occur in the direction orthogonal to the surface moving direction. The predetermined partial portion may be determined by the manufacturer of the image forming apparatus.

### Fifth Aspect

According to a fifth aspect, in the image forming apparatus (500) of the fourth aspect, the predetermined partial portion is outside a region facing a transfer body in the direction orthogonal to the surface moving direction of the intermediate transferor, and is a region to which the lubricant from the lubricant supplier (13) is applied.

### Sixth Aspect

According to a sixth aspect, in the image forming apparatus (500) of any one of the first to fifth aspects, a toner inputter adjusts the amount of toner according to a predetermined condition before the determiner (302) determines that the non-supply portion (A) is present on the intermediate transferor (8), and when the determiner (302) determines that the non-supply portion (A) is present on the intermediate transferor (8), the toner inputter increases the amount of toner greater than the amount of toner according to the predetermined condition before the determiner (302) determines that the non-supply portion (A) is present on the intermediate transferor (8).

### Seventh Aspect

According to a seventh aspect, in the image forming apparatus (500) of the sixth aspect, the predetermined condition comprises a condition associated with at least one of a temperature in the image forming apparatus (500) and a linear speed of the image forming apparatus (500).

According to this, when the internal temperature or the temperature in the vicinity of the cleaner (31) is high, the blade-curling is likely to occur, and when the internal temperature or the temperature in the vicinity of the cleaner (31) is low, the blade-curling is less likely to occur.

Therefore, in a case where the internal temperature or the temperature in the vicinity of the cleaner (31) is high and the curling is likely to occur, the increase amount of the toner input amount is increased, and in a case where the internal temperature or the temperature in the vicinity of the cleaner (31) is low, the increase amount of the toner input amount is made smaller than that in a case where the temperature is high, so that it is possible to prevent a large amount of toner from being unnecessarily input and to reduce the toner consumption amount.

The faster the linear speed at the time of image formation, the more easily the curling occurs. Therefore, by increasing the increase amount of the toner input amount when the linear speed is fast (for example, 300 mm/s) and decreasing the increase amount of the toner input amount when the linear speed is slow (256 mm/s) as compared with the case where the linear speed is fast, it is possible to prevent a large amount of toner from being unnecessarily input and to reduce the toner consumption amount.

### Eighth Aspect

According to an eighth aspect, in the image forming apparatus (500) of any one of the first to seventh aspects, a black toner image bearer (1) on which a black toner image is formed and at least one color toner image bearer (1) on which a color toner image is formed are provided as the image bearers (1) so as to face a common intermediate transferor (8), the lubricant supplier (13) is provided in each of the black toner image bearer (1) and the at least one color toner image bearer (1), and the determiner (302) performs determination as to the non-supply portion (A) of the lubricant from the lubricant supplier (13) of the black toner image bearer (1).

According to this, by determining the lubricant depletion based on the travel distance of the latent image bearer of Bk or the number of printed sheets with which the lubricant depletion is most likely to occur, it is possible to reliably prevent the occurrence of the curling.

### Ninth Aspect

According to a ninth aspect, in the image forming apparatus (500) of any one of the first to eighth aspects, when an input toner image is formed, multiple input toner images is formed at intervals in a moving direction of the intermediate transferor (8).

According to this, it is possible to achieve both filming prevention and cleaning performance before the lubricant is depleted, and it is possible to prevent filming, achieve cleaning performance, and prevent blade-curling after the lubricant is depleted.

### Tenth Aspect

According to a tenth aspect, in the image forming apparatus (500) of any one of the first to ninth aspects, the amount of toner is increased by at least one of increasing a length of the toner image in a moving direction of the image bearer (1), increasing the number of the toner images in the moving direction of the image bearer (1), increasing a formation frequency (formation frequency of toner image input patterns with respect to the travel distance of the latent image bearer or the number of printed sheets) of the toner image, and increasing a toner attachment amount per unit area of the toner image.

According to this, the lubricant component does not come due to the lubricant depletion, and the curling is likely to occur, but the toner input amount to the blade can be increased to prevent the curling.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or a digital versatile disk (DVD), and/or the memory of an FPGA or ASIC.

1. An image forming apparatus comprising:
multiple intermediate-transferor facing members including an image bearer on which a toner image is formed;
an intermediate transferor disposed facing the multiple intermediate-transferor facing members, the intermediate transferor to which the toner image is transferred from the image bearer;
a transferor to transfer the toner image from the intermediate transferor onto a recording medium;
a cleaner to clean a surface of the intermediate transferor after the toner image is transferred onto the recording medium;
a lubricant supplier to supply a lubricant to the intermediate transferor via one intermediate-transferor facing member of the multiple intermediate-transferor facing members; and
circuitry configured to:
form a toner pattern, on the surface of the image bearer, in a portion where the toner image is not formed;
control the transferor to transfer the toner pattern onto the intermediate transferor and input the toner pattern to a contact portion of the cleaner with the image bearer;
determine whether a non-supply portion is present on the intermediate transferor, the non-supply portion being a portion where the lubricant is not supplied due to a decrease in the lubricant supplied from the lubricant supplier; and
increase an amount of toner in the toner pattern input to the contact portion of the cleaner based on a determination result that the non-supply portion is present.

2. The image forming apparatus according to claim 1,
wherein the circuitry determines whether the non-supply portion is present on the intermediate transferor based on a cumulative movement amount of the surface of the intermediate-transferor facing member from a start of use of the lubricant.

3. The image forming apparatus according to claim 1, wherein
the one intermediate-transferor facing member is the image bearer, and
the circuitry determines that the non-supply portion is present on the intermediate transferor based on a fact that a cumulative number of times of image formation from start of use of the lubricant has reached a threshold number of times, or a fact that a cumulative surface moving distance of the image bearer has reached a threshold distance.

4. The image forming apparatus according to claim 1, wherein
the non-supply portion extends partially on the intermediate transferor in a direction orthogonal to a surface moving direction of the intermediate transferor, and
the circuitry increases the amount of toner input at least to a predetermined partial portion in the direction orthogonal to the surface moving direction, the predetermined partial portion being a portion where the non-supply portion is expected to occur.

5. The image forming apparatus according to claim 4, wherein
the predetermined partial portion is outside a region where the recording medium faces in the direction orthogonal to the surface moving direction of the intermediate transferor, and
the lubricant from the lubricant supplier is applied to the predetermined partial portion.

6. The image forming apparatus according to claim 1, wherein
the circuitry adjusts the amount of toner input to the contact portion according to a condition before the circuitry determines that the non-supply portion is present on the intermediate transferor, and
when the circuitry determines that the non-supply portion is present on the intermediate transferor, the circuitry increases the amount of toner input to the contact portion greater than the amount of toner adjusted according to the condition.

7. The image forming apparatus according to claim 6,
wherein the condition includes at least one of a temperature in the image forming apparatus or a condition associated with a linear speed of the image forming apparatus.

8. The image forming apparatus according to claim 1, wherein
the image bearer includes a black toner image bearer on which a black toner image is formed, and a color toner image bearer on which a color toner image is formed,
the black toner image bearer and the color toner image bearer are disposed facing the intermediate transferor,
the lubricant supplier includes a first lubricant supplier to supply the lubricant to the black toner image bearer, and a second lubricant supplier to supply the lubricant to the color toner image bearer, and
the circuitry determines whether the non-supply portion caused by the decrease in the lubricant supplied from the first lubricant supplier is present.

9. The image forming apparatus according to claim 1,
wherein the circuitry forms multiple toner patterns, including the toner pattern, at intervals in a surface moving direction of the intermediate transferor.

10. The image forming apparatus according to claim 1,
wherein the circuitry performs at least one of increasing a length of the toner pattern in a surface moving direction of the image bearer, increasing a number of the toner pattern in a moving direction of the image bearer, increasing a formation frequency of the toner pattern, or increasing a toner attachment amount per unit area of the toner pattern, to increase the amount of toner input to the contact portion.

11. An image forming apparatus comprising:
an image bearer;
a means for forming a toner pattern, on a surface of an image bearer, in a portion where a toner image to be transferred onto a recording medium is not formed;
an intermediate transferor disposed facing the image bearer, the intermediate transferor to which the toner image is transferred from the image bearer;
a means for primarily transferring the toner pattern from the image bearer onto the intermediate transferor;
a means for secondarily transferring the toner image from the intermediate transferor onto the recording medium;
a cleaner for cleaning a surface of the intermediate transferor after the toner image is transferred onto the recording medium;
a lubricant supplier for supplying a lubricant to the intermediate transferor via the image bearer;
a means for inputting the toner pattern to a contact portion of the cleaner with the image bearer;
a means for determining whether a non-supply portion is present on the intermediate transferor, the non-supply portion being a portion where a lubricant is not supplied due to a decrease in the lubricant supplied from the lubricant supplier; and
a means for increasing an amount of toner in the toner pattern input to the contact portion of the cleaner based on a determination result that the non-supply portion is present.

12. A method for forming a toner pattern, the method comprising:
forming a toner pattern, on a surface of an image bearer, in a portion where a toner image to be transferred onto a recording medium is not formed;
controlling a transferor to transfer the toner pattern onto an intermediate transferor and input the toner pattern to a contact portion of a cleaner with the image bearer;
determining whether a non-supply portion is present on the intermediate transferor, the non-supply portion being a portion where a lubricant is not supplied; and
increasing an amount of toner in the toner pattern input to the contact portion of the cleaner based on a determination result that the non-supply portion is present.
